(19) United States
(12) Patent Application Publication
(10) Pub. No.: US 2024/0335267 A1
(43) Pub. Date: Oct. 10, 2024

(54) ELECTRIC TOOTHBRUSH AND MOLDING PROCESS OF HANDLE HOUSING

(71) Applicant: Guangzhou Stars Pulse Co., Ltd., Guangzhou (CN)

(72) Inventors: Wanyu LIAO, Guangzhou (CN); Kebi Ding, Guangzhou (CN); Shihua Liu, Guangzhou (CN); Zhendong Huang, Guangzhou (CN); Xiaobo Zheng, Guangzhou (CN); Kunguang Liu, Guangzhou (CN)

(21) Appl. No.: 18/749,539

(22) Filed: Jun. 20, 2024

Related U.S. Application Data
(63) Continuation-in-part of application No. PCT/CN2023/120689, filed on Sep. 22, 2023.

(30) Foreign Application Priority Data
Mar. 16, 2023 (CN) 202310265274.2
Mar. 16, 2023 (CN) 202320534403.9
Apr. 6, 2023 (CN) 202320752790.3

(51) Int. Cl. A61C 17/22; A46B 5/02; A46B 13/02; A46B 15/00; A46D 3/00; A61C 1/08

(52) U.S. Cl. CPC A61C 17/225; A46B 5/026; A46B 13/023; A46B 15/0044; A46B 15/0087; A46D 3/00; A61C 1/088

(57) ABSTRACT

The present disclosure provides a handle housing of an electric toothbrush, an electric toothbrush and a molding process of the handle housing, the electric toothbrush comprising: a light-emitting element disposed in the handle housing, the handle housing including: a machine casing, a display casing and at least one button, an accommodating cavity for accommodating the light-emitting element is formed in the machine casing, and an installation groove communicated to the accommodating cavity is formed on the outer surface of the machine casing, the display casing is located in the installation groove, the display casing has a display area for transmitting lights emitted by the light-emitting element, and the at least one button is connected to the display casing.

### TECHNICAL FIELD

The present disclosure relates to the technical field of oral cleaning, and specifically, to a handle housing of an electric toothbrush, an electric toothbrush, and a molding process of the handle housing.

### BACKGROUND

In the related technical field, some electric toothbrushes include components with display functions and buttons with display functions, these components and buttons are often provided separately, and both of the component and buttons are connected to a housing of the electric toothbrush. As a result, an assembly process of electric toothbrushes is more complicated.

### SUMMARY OF DISCLOSURE

The present disclosure provides a handle housing of an electric toothbrush, an electric toothbrush and a molding process of the handle housing, wherein, aiming to provide a button on a display casing, and connect the display casing to the machine casing, thereby reducing an assembly process of the handle housing, to reduce the overall assembly cost of the electric toothbrush, and improve the overall assembly efficiency of the electric toothbrush.

The present disclosure provides a handle housing of an electric toothbrush. The electric toothbrush comprising: a light-emitting element provided in a handle housing, the handle housing including: a machine casing, a display casing, and at least one button; the machine casing having an installation groove, an accommodating cavity for accommodating the light-emitting element is formed in the machine casing, and the installation groove communicated to the accommodating cavity is formed on the outer surface of the machine casing, the display casing is located in the installation groove, the display casing has a display area for transmitting the light emitted by the light-emitting element; the at least one button is provided on the display casing, and arranged at intervals or adjacent to the display area.

The present disclosure further provides an electric toothbrush, the electric toothbrush including: a handle housing of an electric toothbrush, a movement component, and a light-emitting element, the movement component is provided in a machine casing, and the movement component including a mounting bracket, the light-emitting element is installed on the mounting bracket, a light emitted by the light-emitting element can emitted out from a display area.

The present disclosure provides a molding process of a handle housing of an electric toothbrush, which is suitable for manufacturing the handle housing, the molding process of the handle housing including: molding out a display casing; molding out a machine casing on the display casing, so that the display casing and the machine casing are integrally molded, and connecting the at least one button to the display casing.

Based on a handle housing of the present disclosure, since providing the button on the display casing, and connecting the display casing to the machine casing, comparing with the display casing and the button being connected to the machine casing separately, the assembly process of the handle housing may be reduced, to reduce the assembly cost of the handle housing, thereby reduce the overall cost of the electric toothbrush, and the overall assembly efficiency of the electric toothbrush may be improved.

### BRIEF DESCRIPTION OF THE DRAWINGS

In order to explain the embodiments of the present disclosure or the technical solutions in the prior art clearly, the drawings needed to be used in the description of the embodiments or the prior art will be briefly introduced below, obviously, the drawings in the following description are only some embodiments of the present application, for those skilled in the art, other drawings may be obtained based on these drawings without exerting creative efforts.

FIG. 1 is a structural schematic diagram of an electric toothbrush of a first embodiment of the present disclosure.

FIG. 2 is a structural schematic diagram of a partial cross section of the electric toothbrush of the first embodiment of the present disclosure.

FIG. 3 is a partial exploded structural schematic diagram of the electric toothbrush of the first embodiment of the present disclosure.

FIG. 4 is a structural schematic diagram of a partial cross section of an electric toothbrush of a second embodiment of the present disclosure.

FIG. 5 is a partial exploded structural schematic diagram of the electric toothbrush of the second embodiment of the present disclosure.

FIG. 6 is a cross-sectional structural schematic diagram of an electric toothbrush of the first embodiment of the present disclosure.

FIG. 7 is an enlarged structural schematic diagram of a part A in FIG. 6.

FIG. 8 is a cross-sectional structural schematic diagram of the electric toothbrush of the second embodiment of the present disclosure.

FIG. 9 is an exploded structural schematic diagram of a display casing of the first embodiment of the present disclosure.

FIG. 10 is a structural schematic diagram of the display casing of the first embodiment of the present disclosure.

FIG. 11 is a flow diagram of a molding process of a handle housing of the first embodiment of the present disclosure.

FIG. 12 is a flow diagram of a molding process of a handle housing of the second embodiment of the present disclosure.

FIG. 13 is a flow diagram of a molding process of a handle housing of a third embodiment of the present disclosure.

FIG. 14 is a flow diagram of a molding process of a handle housing of a fourth embodiment of the present disclosure.

FIG. 15 is a flow diagram of a molding process of a handle housing of the fourth embodiment of the present disclosure.

FIG. 16 is a flow diagram of a molding process of a handle housing of the fourth embodiment of the present disclosure.

FIG. 17 is a flow diagram of a molding process of a display casing of the first embodiment of the present disclosure.

FIG. 18 is a flow diagram of a molding process of a display casing of the second embodiment of the present disclosure.

FIG. 19 is a flow diagram of a molding process of a display casing of the third embodiment of the present disclosure.

### DESCRIPTIONS ABOUT MAIN DRAWING REFERENCE SIGNS

1, electric toothbrush
11, handle housing
111, machine casing
111A, installation groove
111B, light-transmitting hole
111C, connecting end
111D, free end
111E, accommodating cavity
112, display casing
112A, display area
112A1, planar part
112B, button hole
112C, clipping area
112D, reserved area
1121, outer casing part
11211, light-transmitting substrate
11212, light-transmitting appearance layer
11213, middle layer
11213A, Light-shielding area
11214, pattern layer
11214A, alignment pattern
11215, optical film layer
1122, inner casing part
1123, connecting part
113, button
1131, soft rubber part
1132, inner extension part
12, movement component
121, mounting bracket
122, electrical motor
123, battery
124, circuit board
125, button switch
13, brush
14, light-emitting element
141, display screen
141A, light-emitting area
142, lamp bead
15, bearing member
15A, light guide groove
16, light bar

### DESCRIPTION

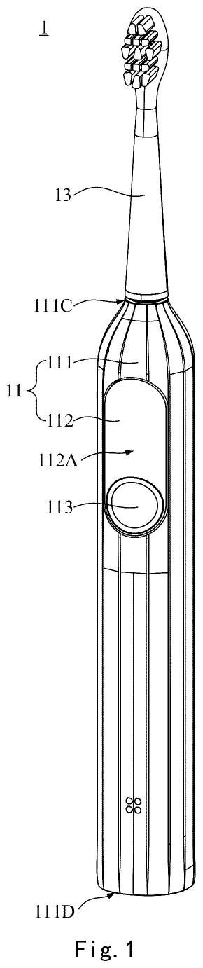

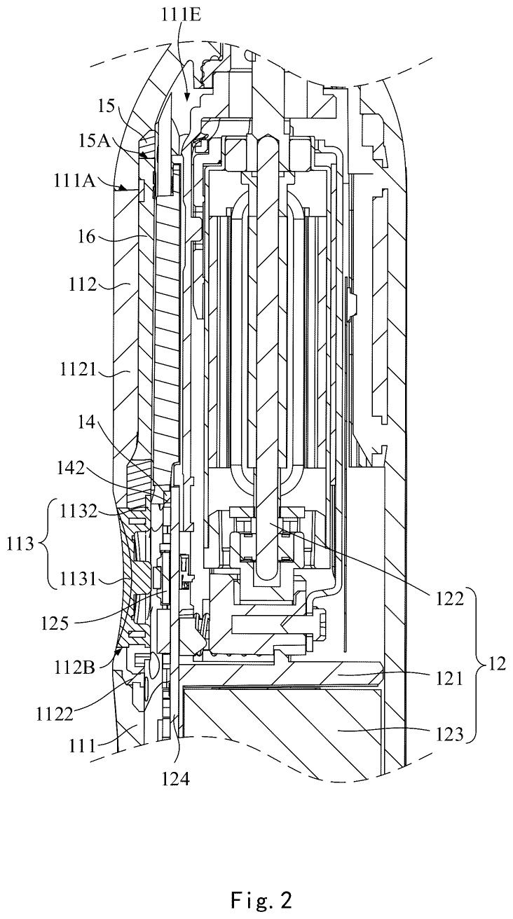

As illustrated in FIG. 1 and FIG. 2, the present disclosure provides an electric toothbrush 1 for cleaning an oral cavity of users. The electric toothbrush 1 including a handle housing 11, a movement component 12, and a brush head 13.

The handle housing 11 is suitable for being held by a user and can protect components within the handle housing 11. For example, the handle housing 11 may be made of plastic to reduce the mass of the electric toothbrush 1, thereby facilitating the use of the electric toothbrush 1 by the user. For example, the handle housing 11 may be integrally molded through an injection molding process, so that the handle housing 11 has a high structural strength and can provide a reliable protection for the movement component 12.

The movement component 12 is provided in the handle housing 11, the movement component 12 is the main component that makes the electric toothbrush 1 vibrate and realizes functions of the tooth brushing. For example, the movement component 12 is included a mounting bracket 121, an electrical motor 122 and a battery 123.

The mounting bracket 121 is configured for installing the electrical motor 122 and the battery 123, so that the movement component 12 is formed as a whole, thereby facilitating the installation of the movement component 12 into the machine casing 111. For example, the mounting bracket 121 may be made of plastic materials to reduce the weight of the mounting bracket 121, thereby reducing the overall weight of the electric toothbrush 1, so that facilitating the use of the electric toothbrush 1 by the user. For example, the mounting bracket 121 may be integrally molded through an injection molding process, so that the mounting bracket 121 has a high structural strength, and the mounting bracket 121 may stably support the electrical motor 122 and the battery 123, thereby improving the overall structural stability of the movement component 12.

The electrical motor 122 has an output shaft which passes through the handle housing 11 to be coupled to the brush head 13. The battery 123 is electrically connected to the electrical motor 122, so that the battery 123 can power the electrical motor 122, so that when using the electric toothbrush 1 to clean the oral cavity, the electrical motor 122 can drive the brush head 13 to move, so that the brush head 13 is caused to vibrate in the oral cavity of the user, thereby cleaning the oral cavity.

As illustrated in FIG. 1 and FIG. 2, the electric toothbrush 1 including a light-emitting element 14 disposed in the handle housing 11. The light-emitting element 14 is electrically connected to the battery 123, so that the battery 123 can power the light-emitting element 14, and the light-emitting element 14 emits light. In the embodiment, the light-emitting element 14 can be for example a light source for a backlight, or can be a display device capable of displaying patterns. This embodiment is not limited to this, and the light-emitting element 14 may be electrically connected to a controller of the electric toothbrush 1 to work under the control of a controller.

Referring to FIG. 1 and FIG. 2, the handle housing 11 is included a machine casing 111, a display casing 112 and a button 113. The machine casing 111 cooperating with the display casing 112 form a main external casing of the handle housing 11

The machine casing 111 is the main component held by the user in the handle housing 11, and is configured for protecting internal components such as the movement component 12. The machine casing 111 has an accommodating cavity 111E for accommodating the light-emitting element 14, and an installation groove 111A formed on the outer surface of the machine casing 111, and configured for installing the display casing 112.

The display casing 112 is a housing part of the handle housing 11, which has a display function or assists in realizing the display function. The images generated by the display casing 112 or the contents generated by other components of the electric toothbrush 1 (such as the light-emitting element 14) through the display casing 112 are not limited, for example, the display casing 112 can display a current operating mode of the toothbrush at least one of a current operating mode, brushing area, brushing duration, pressing force and other information of the electric toothbrush 1.

The display casing 112 is installed in the installation groove 111A, the display casing 112 has a display area 112A with a light-transmitting property, i.e., the display casing 112 has a light-transmitting area, the light-emitting element 14 is disposed corresponding to the light-transmitting area, so that the light emitted by the light-emitting element 14 is emitted from the display area 112A, and the display area 112A is highlighted compared to other areas of the display casing 112, thereby facilitating the user to obtain the displayed content through the highlighted display area 112A. The display area 112A may be a transparent housing part of the display casing 112, so that the light emitted by the light-emitting element 14 may be emitted from the display area 112A. For example, the display area 112A may be a through hole throughout the display casing 112, and integrally molding a light-transmitting substrate in the through hole, which can also facilitate the light emitted by the light-emitting element 14 to emit out from the display area 112A, and for using light-transmitting substrate can prevent water and dirt from entering the accommodating cavity 111E through the through hole, thereby providing a reliable protection for the movement component 12, to ensure that the electric toothbrush 1 has a long service life.

The button 113 may be pressed by the user, so that the user can control the electric toothbrush 1 through the button 113, the specific type of the button 113 is not limited in the present disclosure. The button 113 may be such as a switch button for controlling the electric toothbrush 1 to turn on and off, or a mode switching button for switching operating modes of the electric toothbrush 1, and different operating modes causes the brush head 13 to have different vibration frequencies and/or operating frequencies.

In some embodiments, the button 113 is disposed on the display casing 112 and arranged at intervals from the display area 112A. thereby reducing the probability that user fingers block the display area 112A when operating the button 113.

In another embodiments, the button 113 may also be arranged adjacent to the display area 112A, so that the display area 112A may be placed close to the button 113, which can improve the surface utilization of the display casing 112, thereby obtaining a larger display area 112A on the same size of the display casing 112, to make it easier to observe display contents of the display area 112A.

Comparing to a traditional handle housing including both its display casing 112 and a button 113 separately connected to the machine casing 111, since providing the button 113 is provided on the display casing 112, and then the display casing 112 is connected to the machine casing 111, so that the button 113 is connected to the machine casing 111 through the display casing 112, the assembly process of the handle housing 11 may be reduced, thereby reducing the assembly cost of the handle housing 11, so as to reduce the overall cost of the electric toothbrush 1. That is, the overall assembly efficiency of the electric toothbrush 1 may be improved.

As illustrated in FIG. 1 and FIG. 2, the button 113 is integrally molded on the display casing 112 to eliminate a gap between the button 113 and the display casing 112. Therefore, dirt or grime will not accumulate between the display casing 112 and the outer contour of the button 113, and bacteria will not breed, thereby improving the hygiene of the electric toothbrush 1. Liquid will not enter the interior of the handle housing 11 from the position between the display casing 112 and the button 113, which can effectively avoid short circuit of the electrical components in the handle housing 11. In addition, since the display casing 112 and the button 113 are integrally molded through an injection molding process, the connection strength between the display casing 112 and the button 113 may be improved, and the probability of the button 113 falling off from the display casing 112 due to multiple presses may be reduced. Compared with separately manufacturing the display casing 112 and the button 113 and then assembling them, this embodiment also omits the assembly steps, which is beneficial to improve the assembly efficiency of the electric toothbrush 1.

In the embodiment, the injection molding process between the display casing 112 and the button 113 can be such as a double injection molding manufacture method or a secondary injection molding manufacture method (also referred as an over-molding process or an encapsulation process for flexible or soft plastic).

As illustrated in FIG. 1 and FIG. 2, the display casing 112 is integrally molded with the machine casing 111 as a whole for eliminating a gap between the outer surface of the display casing 112 and the outer surface of the machine casing 111, it not only makes the handle housing 11 being more integrated, but also makes the gap between the outer surface of the display casing 112 and the outer surface of the machine casing 111 being eliminated, dirt or grime will not accumulate between the outer surface of the display casing 112 and the surface of the machine casing 111, and bacteria will not breed, thereby improving the hygiene of the electric toothbrush 1. Liquid will also not enter the interior of the handle housing 11 through the outer surface of the display casing 112 and the machine casing 111, which can effectively avoid short circuit of the electrical components in the handle housing 11. In addition, since the display casing 112 and the machine casing 111 are integrally molded as a whole through an injection molding process, the connection strength between the display casing 112 and the machine casing 111 is improved. Compared to the traditional handle housing that is formed by separately manufacturing the display casing 112 and the machine casing 111 and then assembling them, this embodiment also omits the assembly steps, which is beneficial to improving the assembly efficiency of the electric toothbrush 1.

In this embodiment, the injection molding process between the display casing 112 and the machine casing 111 can be a double injection molding process or a secondary injection molding process or a two-shot injection molding process (also referred as an over-molding process or an encapsulation process for flexible or soft plastic).

As illustrated in FIG. 1 and FIG. 2, the button 113 may be integrally molded on the display casing 112, and the display casing 112 may be integrally molded with the machine casing 111 through the injection molding process, to eliminate a gap between the outer contour of the button 113 and the display casing 112 and a gap between the outer surface of the display casing 112 and the outer surface of the machine casing 111, so that dirt or grime will not accumulate, and bacteria will not breed in the gaps, thereby improving the hygiene of the electric toothbrush 1.

As illustrated from FIG. 1 to FIG. 3, the display casing 112 has at least one button hole 112B throughout the display casing 112, at least a part of at least one button 113 is formed integrally with the hole wall of the at least one button hole 112B.

In some embodiments, the button 113 at least includes: an edge part 113A that matches a shape of the hole wall of the at least one button hole 112B, at least one button 113 is integrally molded with the hole wall of the at least one button hole 112B through the edge part 113A, so that the at least one button 113 and the hole wall of the at least one button hole 112B are integrally molded.

In this present application, the meaning of “be integrally molded with” may be forming into one body by one process or multiple processes and is not limited to forming into one body by injection molding process which can also be replaced by processes such as welding.

In some embodiments, the button 113 includes: a pressing part 113B accommodated in the button hole 112B and at least one inner extension part 1132 connected to the pressing part 113B, the at least one inner extension part 1132 is extended from the pressing part 113B through an inner wall of the display casing 112 to the inner wall of the machine casing 111, and the at least one inner extension part 1132, the inner wall of the display casing 112, and the inner wall of the machine casing 111 are integrally molded.

In some embodiments, the button 113 includes: a soft rubber part 1131 accommodated in the at least one button hole 112B and integrally molded with a hole wall of the at least one button hole 112B, and the soft rubber part 1131 is partially exposed on the display casing 112, to suitable for being pressed by the fingers of a user, i.e., at least a part of the soft rubber part 1131 is constituted as the pressing part 113B. The movement component 12 further includes: a circuit board 124 provided on the mounting bracket 121. The circuit board 124 is provided with a button switch 125 corresponding to the at least one button hole 112B. When pressing the button 113, the soft rubber part 1131 deforms toward the at least one button hole 112B, to exert force on the button switch 125, thereby controlling the electric toothbrush 1. Since the soft rubber part 1131 is integrally molded with the hole wall of the at least one button hole 112B, the gap between the button 113 and the display casing 112 is eliminated. For example, the material of the soft rubber part 1131 may be a flexible plastic, such as silicone, so that the soft rubber part 1131 can obtain a longer service life, and also the user can have a more comfortable pressing feeling when pressing.

The at least one button 113 further includes: an inner extension part 1132 connected to one end of the soft rubber part 1131 that penetrates into the interior of the machine casing 111 through the at least one button hole 112B, and the inner extension part 1132 extends from the soft rubber part 1131 to a direction away from the at least one button hole 112B along an inner wall of the display casing 112 to increase the contact area between the at least one button 113 and the display casing 112, thereby improving stability of the connection between the at least one button 113 and the display casing 112. Furthermore, the inner extension part 1132 is integrally molded with the inner wall of the display casing 112, which further improves the connection stability between the at least one button 113 and the display casing 112 and reduces the probability that the at least one button 113 falls off from the display casing 12 due to being pressed multiple times. The inner extension part 1132 extends from the soft rubber part 1131 to a direction away from the at least one button hole 112B along the inner wall of the display casing 112, to limit the movement component of the button 113 from the interior of the handle housing 11 to the outside of the handle housing 11, thereby preventing the button 113 being detached outwards from the handle housing 11.

In this embodiment, the inner extension part 1132 may be made of the same material as the soft rubber part 1131, for example, the inner extension part 1132 can be made of soft rubber, so that the inner extension part 1131 can be molded out simultaneously with the soft rubber part 1132, That is to say, the soft rubber part 1131 and the inner extension part 1132 are integrally injection molded, which can not only increase the connection stability between the soft rubber part 1131 and the inner extension part 1132, but also reduce the molding process and the number of injection molds used, thereby reducing injection molding costs.

In some embodiments, the inner extension 1132 continues to extend from the soft rubber part 1131 through the inner wall of the display casing 112 to the inner wall of the machine casing 111, and the inner extension part 1132 is integrally molded with the inner wall of the machine casing 111 through an injection molding process, so that the contact area between the inner extension part 1132 and the inner surface of the handle housing 11 can further be increased, and the connection stability between the button 113 and the handle housing 11 can further be increased. And the inner extension 1132 continues to extend from the soft rubber part 1131 through the inner wall of the display casing 112 to the inner wall of the machine casing 111, so that the contact area between the inner extension part 1132 and the inner wall of the display casing 112 can further be increased, thereby improving the connection stability between the display casing 112 and the machine casing 111.

In addition, combining with the embodiment in which the display casing 112 and the machine casing 111 are integrally molded, the button 113 is integrally molded with the display casing 112 through the soft rubber part 1131 and a part of the inner extension part 1132, the button 113 is also integrally molded with the machine casing 111 through the remaining part of the inner extension part 1132, i.e., the machine casing 111, the display casing 112 and the button 113 are connected to each other through an integrated molding process, and form a structure similar to a triangular connection, thereby improving the stability between the machine casing 111, the display casing 112, and the button 113.

As illustrated from FIG. 1 to FIG. 5, the inner extension part 1132 is arranged surrounding the circumferential side of the soft rubber portion 1131, so that the circumferential side of the soft rubber portion 1131 may be in contact with the inner wall of the handle housing 11, and the rubber part 1131 is evenly stressed to improve the connection stability between the button 113 and the display casing 112. In the direction from the interior of the display casing 12 to the outside, a circle of inner extension part 1132 are connected to the inner wall of the display casing 12, which can prevent the button 113 falling off the display casing 112 from an inner to an outer. It may be understood that the embodiment in which the inner extension part 1132 is arranged around the circumferential side of the soft rubber part 1131 may be combined with the embodiment in which the inner extension part 1132 and the soft rubber part 1131 are integrally injection molded, that is, the inner extension part 1132 is integrally molded out on the circumferential side of the soft rubber part 1131, certainly, the inner extension part and the soft rubber part can also be molded out separately.

As illustrated from FIG. 1 to FIG. 5, the display casing 112 including an outer casing part 1121 and an inner casing part 1122, the outer casing part 1121 is installed in the installation groove 111A, and has a display area 112A; the inner casing part 1122 is connected to the outer casing part 1121, and disposed on the side of the outer casing part 1121 adjacent to the movement component 12, and is extended from the outer casing part 1121 along an inner wall of the machine casing 111 to a direction away from the installation groove 111A, so that the contact area between the display casing 112 and the inner wall of the machine casing 111 is increased, thereby improving the connection stability between the display casing 112 and the machine casing 111, and making it difficult for the display casing 111 to come out of the machine casing 111.

Furthermore, the outer casing part 1121 may be integrally molded with the groove wall of the installation groove 111A through an injection molding process, so that it not only improves the tightness and connection stability of the outer casing part 1121 and the machine casing 111, but also because the outer casing part 1121 and the machine casing 111 are integrally molded, the gap between the outer casing part 1121 and the machine casing 111 may be eliminated, and dirt or grime will not accumulate in the connection position between the outer casing part 1121 and the machine casing 111, and bacteria will not breed.

As illustrated from FIG. 1 to FIG. 5, furthermore, the inner casing part 1122 and the inner wall of the machine casing 111 may be integrally molded through an injection molding process, so that the inner casing part 1122 and the inner wall of the machine casing 111 may be tightly connected to improve the connection stability of the display casing 112 and the machine casing 111, and if a crack occurs at the connection between the outer casing part 1121 and the machine casing 111, since the inner casing part 1122 and the inner wall of the machine casing 111 are integrally molded, the inner casing part 1122 and the inner wall of the machine casing 111 form a sealed connection, which can also effectively prevent external liquid entering the handle housing 11, thereby avoiding short circuit of the electrical components in the handle housing 11. It may be understood that while the outer casing part 1121 is integrally molded with the groove wall of the installation groove 111A, the inner casing part 1122 is also integrally molded with the inner wall of the machine casing 111, thereby increasing the connection area between the display casing 112 and the machine casing 111, improving the connection stability between the display casing and the housing 111 as a whole, and reducing the probability of the display casing 112 detaching from the machine casing 111.

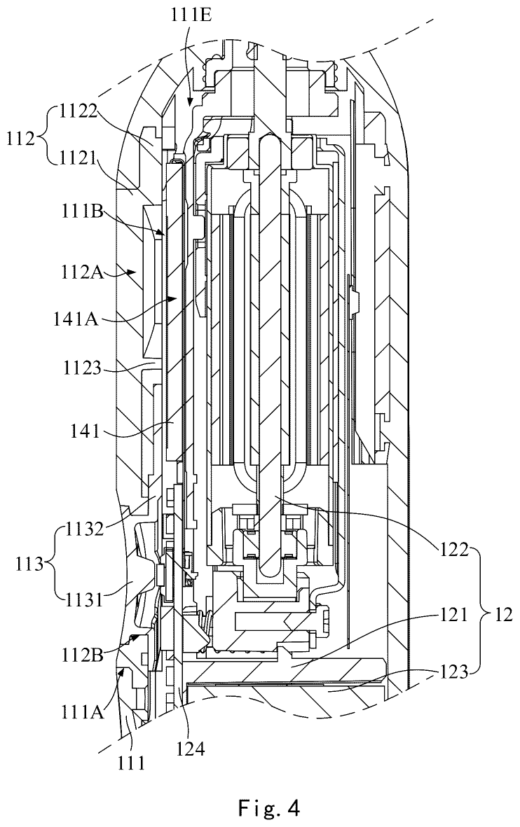

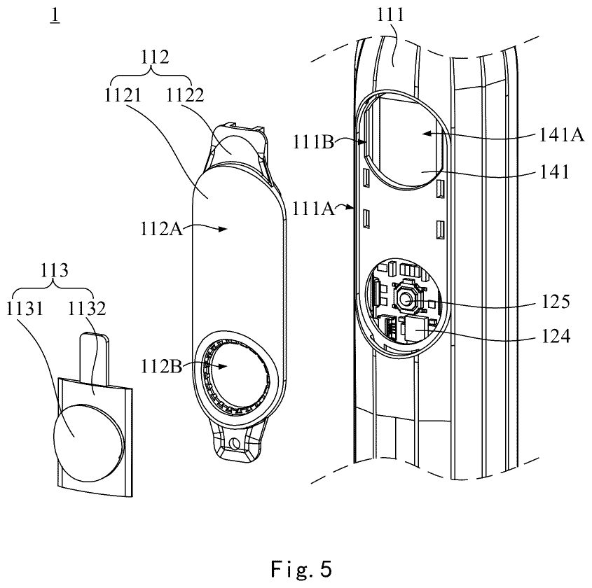

As illustrated in FIG. 1, FIG. 4, and FIG. 5, the light-emitting element 14 includes a display screen 141, having a light-emitting area 141A. The controller of the electric toothbrush 1 can control the light-emitting area 141A of the display screen 141 to emit light for displaying contents. For example, the display screen 141 includes, but is not limited to a Liquid Crystal Display (LCD) or an Organic Light-Emitting Diode Display (OLED). The machine casing 111 has a light-transmitting hole 111B, which is a through hole opened at the bottom of the installation groove 111A. The light-transmitting hole 111B corresponds to the display area 112A, so that a light emitted from the light-emitting area 141A can emitted out through the light-transmitting hole 111B and the display area 112A.

Alternatively, the button 113 may be a mode switching button, when a user presses the button 113, the button 113 transmits a first control signal to the controller to switch the current operating mode of the electric toothbrush 1, and the controller transmits a second control signal to the display screen 141, so that the corresponding light-emitting area 141A on the display screen 141 displays information of the current operating mode, such as text or patterns, the light emitted by the light-emitting area 141A passes through the light-transmitting hole 111B and the display area 112A, and then emits to the outside of the handle housing 11, such that the display area 112A corresponding to the light-emitting area 141A that is displaying content to be in a highlighted state, thereby facilitating users to observe the displayed content through the highlighted display area 112A.

The inner wall surface of the outer casing part 1121 is connected to a connecting part 1123 connected to a hole wall of the light-transmitting hole 111B. The inner casing part 1122 is connected to the connecting part 1123 and passes through the outer circumference side of the light-transmitting hole 111B. The outer casing part 1121, the connecting part 1123, the inner casing part 1122, and the machine casing 111 can integrally be formed through an injection molding process, to increase the connection stability of the outer casing part 1121, the connecting part 1123, the inner casing part 1122, and the machine casing 111.

It may be understood that in some embodiments, when the light-emitting element 14 including a display screen 141, the number of light-transmitting holes 111B is multiple, and the plurality of light-transmitting holes 111B are arranged at intervals along the length direction of the handle housing 11, the number of the light-emitting areas 141A of the display screen 141 are also multiple, and the light-emitting areas 141A correspond to the light-transmitting holes 111B in position by one-to-one correspondence. When a user presses the button 113, the controller controlling the corresponding light-emitting area 141A of the display screen 141 to emit light to illuminate the corresponding light-transmitting holes 111B, thereby highlighting the corresponding display area 112A, so that the user can obtain the display contents of the electric toothbrush 1 through the highlighted display area 112A.

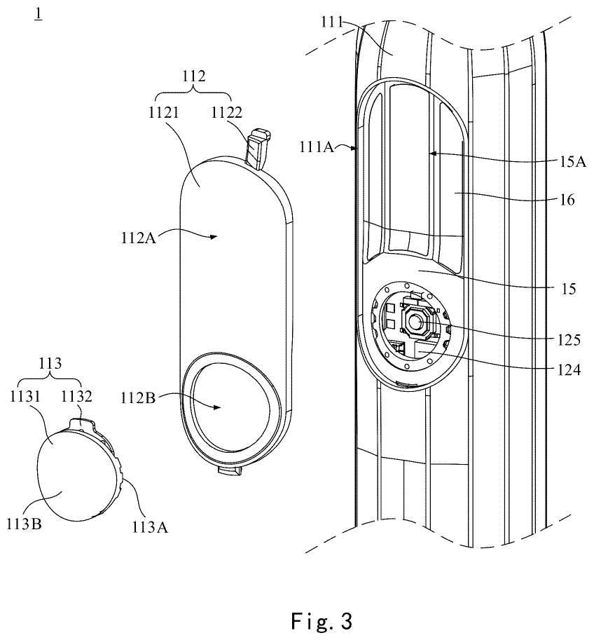

As illustrated in FIG. 1, FIG. 2, and FIG. 3, the light-emitting element 14 can also including lamp beads 142, and the handle housing 11 further including a bearing member 15 and a plurality of light bars 16, the bearing member 15 has a plurality of light guide grooves 15A arranged at intervals; the plurality of light bars 16 are integrally molded with the bearing member 15, and are arranged in the light guide grooves in one-to-one correspondence, and the light emitted by the lamp beads 142 can pass through the light bars 16 and the installation groove 111A in sequence to illuminate the display area 112A, so that the users can obtain the display contents of the electric toothbrush 1 through the highlighted display area 112A.

The light-emitting element 14 includes a plurality of lamp beads 142, these lamp beads 142 are arranged on the mounting bracket 121 and are arranged in one-to-one correspondence with the light bars 16, the light emitted by the lamp beads 142 can enter the corresponding light bars 16, the light is reflected and refracted in the light bars 16, so that the light bars 16 are lit up, and the light of the light bars 16 is emitted to the outside of the machine casing 111 through the display area 112A, so that the display area 112A are lit up, thereby facilitating that the users obtain the display contents of the electric toothbrush 1 through the lit display area 112A.

Since the lighting area of the light bars 16 is larger than the lighting area of the point lights, more lights are emitted out of the machine casing 111 through the display area 112A, thereby making it easier for the user to obtain the display contents of the electric toothbrush 1, Moreover, since the lighting area of the light bars 16 is large, any position in the corresponding display area 112A can provide instructions for the display content obtained by the users, thereby improving the convenience for the user to obtain the display contents of the electric toothbrush 1.

It may be understood that the lamp beads 142 may be disposed on the circuit board 124, and the circuit board 124 can control the lamp beads 142 to light up or light down according to preset programs. For example, the lamp beads 142 specifically may be LED lamps.

As illustrated in FIG. 1, the machine casing 111 has a connecting end 111C for connecting with the brush head 13 and a free end 111D away from the connecting end 111C, An output shaft of the electrical motor 122 extends from the connecting end 111C to the outside of the machine casing 111, and is coupled to the brush head 13, thereby facilitating that when a user cleans oral cavity using the electric toothbrush 1, the electrical motor 122 drives the brush head 13 to move, in order to clean the oral cavity of the user. The display casing 112 is arranged closer to the connection end 111C than the free end 111D, which can prevent the display casing 112 from being blocked by the hand when the user is holding the electric toothbrush 1, thereby making it easier for the user to operate the button 113 and viewing the display area 112A while holding the electric toothbrush 1. Furthermore, the display casing 112A is provided between the connection end 111C of the machine casing 111 and the soft rubber part 1131, so that the display area 112A is un-easier to be blocked by hands, so that the user can obtain the display contents of the electric toothbrush 1 from the display area 112A.

As illustrated from FIG. 1 to FIG. 5, the outer surface of the button 113 and the outer surface of the display casing 112 are smoothly transitioned, which avoids the existence of a step between the outer surface of the button 113 and the outer surface of the display casing 112 to prevent dirt or grime accumulating in the dead corners of the step, thereby providing reliable protections for hygiene of users. And because the outer surface of the button 113 and the outer surface of the display casing 112 are smoothly transitioned, the users will not have a rough feeling when holding the handle housing 11 and pressing the button 113, thereby making it easier for the user to press the button 113 to control the electric toothbrush 1.

In some embodiments, the outer surface of the display casing 112 and the outer surface of the machine casing 111 are smoothly transitioned, which avoids the existence of a step between the outer surface of the display casing 112 and the outer surface of the machine casing 111 to prevent dirt or grime accumulating in the dead corners of the step, thereby providing reliable protections for hygiene of users. And because the outer surface of the display casing 112 and the outer surface of the machine casing 112 are smoothly transitioned, when the user observes the current operating mode of the electric toothbrush 1 through the display casing 112, there is no sense of fragmentation for user, so that the visual experience of user may be improved.

As illustrated from FIG. 1 to FIG. 5, the outer surface of the button 113 and the outer surface of the display casing 112 are smoothly transitioned, and the outer surface of the display casing 112 and the outer surface of the machine casing 111 are smoothly transitioned, so that the outer surface of the handle housing 11 may be compact and integrated, for improving the overall aesthetics of the handle housing 11; and avoiding a step appearing on the outer surface of the handle housing 11, thereby preventing dirt or grime accumulating on the step, and providing reliable protections for personal hygiene of the user.

In some embodiments, the outer contour line of the display area 112A and the contour line of the soft rubber part 1131 are circular or oval, so that both the display area 112A and the soft rubber part 1131 can have larger areas, to facilitate the observations of the display area 112A for the user, and make it easier to press the soft rubber part 1131 by the user, thereby controlling the electric toothbrush 1. Certainly, in other embodiments, the outer contour line of the display area 112A and the contour line of the soft rubber part 1131 are also triangular or rectangular.

As illustrated from FIG. 1 to FIG. 5, the area of the display area 112A on the surface of the display casing 112 is larger than the area of the soft rubber part 1131 on the surface of the display casing 112, so that the area of the display area 112A is larger. It also can make it easier for the user to more clearly observe the display area 112A when pressing the soft rubber part 1131, thereby facilitating the user to obtain the display contents of the electric toothbrush 1.

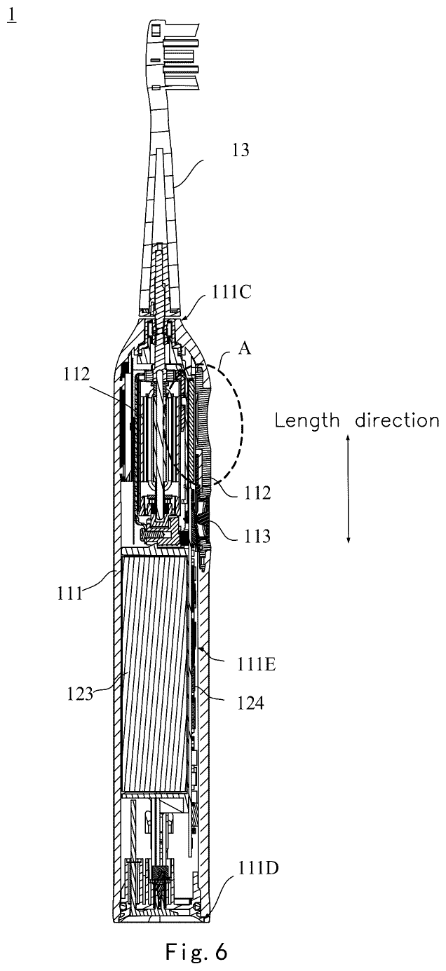

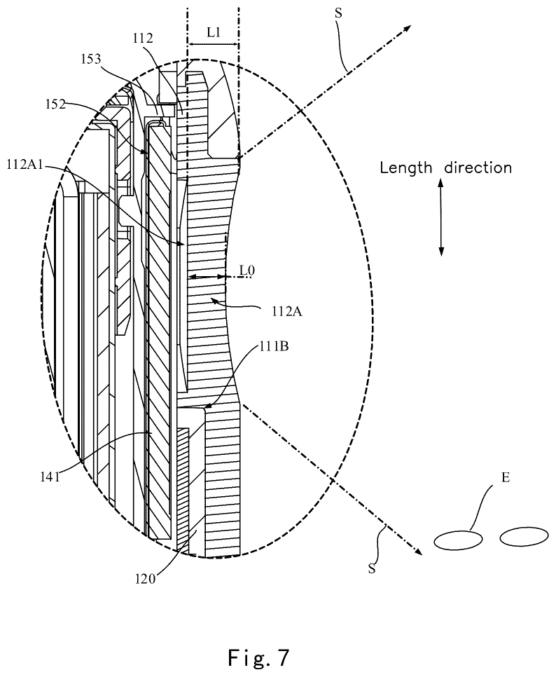

As illustrated in FIG. 6 and FIG. 7, the outer wall surface of the display casing 112 in the display area 112A is configured to be concaved toward the direction of the accommodating cavity 111E. It may be understood that after the display area 112A is formed to be concave, the wall thickness of a part of the display casing 112 which is at least in the display area 112A becomes thinner, to form a structure similar to a concave lens.

Therefore, in the present disclosure, the display area 112A corresponding to the light-transmitting hole 111B on the display casing 112 is provided to be concave toward the direction of the accommodation cavity 111E, so that the display area 112A is formed into a structure similar to a concave lens, due to the characteristics of the imaging principle of a concave lens, the user can more conveniently observe the upright shrunk virtual image of the full texts or full patterns on the display screen 141 at a larger viewing angle outside the display area 112A, which is more convenient to use. At the same time, in the present disclosure, the light-transmitting hole 111B is disposed in a concave form on the outer wall surface, to make the wall thickness of the light-transmitting hole 111B thinner at least internally, and during the molding and production process of the display casing 112, it can also greatly reduce the shrinkage caused by the larger wall thickness of the light-transmitting hole 111B, and greatly reduce the risk for forming concave pits in the light-transmitting hole 111B, and it can ensure the surface flatness of the light-transmitting hole 111B to have a higher displaying effect, and can also improve the yield of product in a production process.

After the outer wall surface of the display casing 112 in the display area 112A of the present disclosure is configured to be concave toward the direction of the accommodating cavity 111E, the displayed final structural forms are presented in a variety of forms, and the forms are illustrated by the following contents.

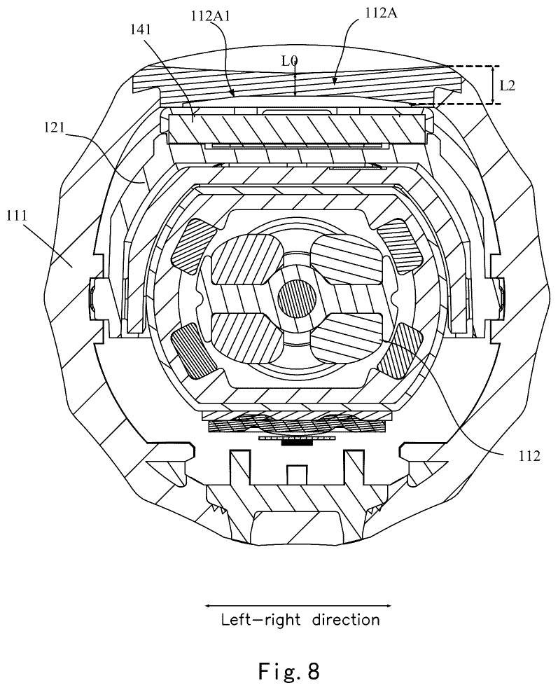

As illustrated in FIG. 7 and FIG. 8, the distance between the outer wall surface of the display casing 112 in the display area 112A and the display screen 141 is gradually decreased from the opposite both sides of the display area 112A in the length direction of the machine casing 111 to the middle part. In details, the distance between the outer wall surface of the display casing 112 on the sides of the display area 112A in the length direction of the machine casing 111 and the display screen 141 is L1, wherein, the distance L1 between the outer wall surface of the display casing 112 in the both sides of the display area 112A in the length direction of the machine casing 111 and the display screen 141 may be equal or different, and the distance between the outer wall surface of the display casing 112 in the middle part of the display area 112A and the display screen 141 is L0, where L0 is smaller than L1, and L1 changes continuously in the process of approaching from the sides to the middle part. Through this arrangement, making the outer wall surface of the display casing 112 in the display area 112A to form a relatively smooth concave surface, which is conducive to forming a display effect of a concave lens, As illustrated in FIG. 7, it can also be seen that two dotted lines S in FIG. 7 indicates that the emitted light formed after the light emitted by the display screen 141 passing through the display area 112A with the characteristics of the concave lens, the area defined between the two emitted lights S are the visual field range that the eyes E of the user can observe, and the design of the present application enables the viewing angle of a user to be obviously increased, and occlusion problems are not easily generated. And the above design of the present application enables the transition of the inner recess of the outer wall surface of the display casing 112 in the display area 112A to be smooth, and concave pits on the surface of the display casing 112 in the display area due to the shrinkage are not easily generated, thus improving the yield of product.

In addition, during actual using processes of the electric toothbrush 1, after the user holds the toothbrush handle, the entire electric toothbrush 1 assuming a tilted posture with a smaller angle between its length direction and the horizontal plane, at this time, the long axis direction of the approximate concave lens structure molded by the display area 112A is also almost horizontal, and the visual field range of the human is usually extended laterally, that is, almost horizontally, so that the two directions are anastomosed, which is more conducive for the user to observe the contents on the display screen 141 and use more conveniently.

Furthermore, the difference between the distance between the outer wall surface of the display casing 112 on either side of the opposite both sides of the display area 112A in the length direction of the machine casing 111 and the display screen 141 and the distance between the outer wall surface of the display casing 112 in the middle part of the display area 112A and the display screen 141 is 0.05 mm to 2 mm (that is, the difference between L1 and L0 is 0.05 mm to 2 mm). The difference between L1 and L0 in this present application can take values of 0.05 mm, 0.06 mm, 0.07 mm . . . 1 mm, 1.01 mm, . . . , 1.5 mm, . . . , 1.99 mm, 2 mm. When the difference is less than 0.05 mm, the positive effect on shrinkage is small and the risk of pits is increased, and when the difference is greater than 2.0 mm, the middle part of the display area 112A is too thin, and its structural strength is smaller and it is easy to break, and the curvature is changed too much, the changes in the contents displayed on the screen observed by the user are inconsistent, so that the display effect is decreased, therefore, this present application is set the difference between L1 and L0 to 0.05 mm to 2 mm. thereby taking into multiple advantages such as good display effect, high production yield, and sufficient structural strength.

It may be understood that the distance between the outer wall of the display casing 112 in the display area 112A and the display screen 141 firstly is decreased from the edge of the display area 112A toward the middle part and then remained unchanged, to make the middle part of the display area 112A relatively flat, and facilitate the form of a concave lens display effect, if the user can more conveniently observe the upright shrunk virtual image of the full texts or full patterns on the display screen 141 at a larger viewing angle outside the display area 121A, which is more convenient to use.

As illustrated in FIG. 1 and FIG. 8, the direction perpendicular to the length direction of the machine casing 111 and parallel to the board surface of the display screen 141 is defined as the left-right direction, the distance between the outer wall surface of the display casing 112 in the display area 112A and the display screen 141 is gradually decreased from the opposite both sides of the display area 112A in the left-right direction to the middle part. As illustrated in the FIG. 8, the distance between the outer wall surface of the display casing 112 on the sides of the display area 112A in the left-right direction and the display screen 141 is L2. In the present application, the distance L2 between the outer wall surface of the display casing 112 on the both sides of the display area 112A in the left-right direction and the display screen 141 may be equal or different, and the distance between the outer wall surface of the display casing 112 in the middle part of the display area 112A and the display screen 141 is still L0, where L0 is smaller than L2, the embodiment in the process of approaching in the left-right direction from the sides to the middle part, L2 changes continuously. Through this arrangement, making the outer wall surface of the display casing 112 in the display area 112A in the left-right direction to form a relatively smooth concave surface, so that similar advantages to the previous embodiment can also be produced. It may be understood that through the arrangement of this embodiment and the principle explanation of the previous embodiment, it may be understood that when the electric toothbrush 1 is placed upright, the user can easily observe the information displayed on the display screen 141.

Furthermore, the difference between the distance L2 between the outer wall surface of the display casing 112 on either side of the opposite both sides of the display area 112A in the left-right direction and the display screen 141, and the distance L0 between the outer wall surface of the display casing 112 in the middle part of the display area 112A and the display screen 141 is 0.05 mm to 1.5 mm (that is, the difference between L2 and L0 is 0.05 mm to 1.5 mm). The difference between L2 and L0 in this present application can be took values of 0.05 mm, 0.06 mm, 0.07 mm . . . 1 mm, 1.01 mm, . . . , 1.3 mm, . . . , 1.49 mm, 1.5 mm. When the difference is less than 0.05 mm, the positive effect on shrinkage is small and the risk of pits is increased, when the difference is greater than 1.5 mm, the middle part of the display area 112A is too thin, and its structural strength is smaller and it is easy to break, and the curvature is changed too much, the changes in the contents displayed on the screen observed by the user are inconsistent, so that the display effect is decreased, therefore, this present application is set the difference between L2 and L0 to 0.05 mm to 1.5 mm. thereby taking into multiple advantages such as good display effect, high production yield, and sufficient structural strength.

It should be noted here that the display area 112A of this present application may be provided individually as follows: the distance between the outer wall surface of the display casing 112 in the display area 112A and the display screen 141 is gradually decreased from the opposite both sides of the display area 112A in the length direction of the machine casing 111 to the middle part, and also may be provided individually as follows: the distance between the outer wall surface of the display casing 112 in the display area 112A and the display screen 141 is gradually decreased from the opposite both sides of the display area 112A in the left-right direction to the middle part, or both of the above disposing forms exist at the same time.

As illustrated in FIG. 7, the outer wall surface of the display casing 112 in the display area 112A is configured to be concave toward the accommodating cavity 111E, the outer contour shape of the display area 112A may also be circular with a concave middle. In this embodiment, the display area 112A is circular, which can focus the eyes and make observation to be more convenient.

Furthermore, when the display area 112A is circular, the wall thickness of the display area 112A is gradually decreased from the outer circle of the circle to the middle part. With this arrangement, the outer wall surface of the display casing 112 in the display area 112A is smoothly recessed toward the middle part, so that the structure of the display area 112A is closer to the structure of a concave lens, based on obtaining better display effects, the stress generated everywhere during the production and molding process may be relatively balanced, concave pits on the surface of the display area due to the shrinkage are not easily generated, thus improving the yield of product.

It may be understood that when the display area 112A is circular, the wall thickness of the display area 112A firstly is decreased from the circular outer circle to the middle part and then then remained unchanged, to make the middle part of the display area 112A relatively flat, and facilitate the form of a concave lens display effect, so that the user can conveniently observe the upright shrunk virtual image of the full texts or full patterns on the display screen 141, which is more convenient to use.

Based on the above contents, it may be understood that this present application is used the concave of the outer wall surface of the display casing 112 in the display area 112A to form an approximate concave lens structure, so that the user obtains a larger visual field range, and uses the characteristics of the concave lens to form an upright shrunk virtual image. When the size of the display screen 141 is larger, the full patterns or full texts on the display screen 141 can also be displayed through the display area 112A.

Based on the above, the present application further limits the area enclosed by the outer contour of the display area 112A to less than 6 square centimeters. In this way, when the whole electric toothbrush 1 tends to be miniaturized and designed to be easier to hold, the surface area of the toothbrush handle occupied by the entire display area 112A will not be too large, so that the display area 112A is much more uniform visually in terms of visual effects, thereby improving the structural consistency of the handle housing 11, ensuring that it has a high structural strength, and can also reduce the cost accordingly.

Furthermore, as illustrated in FIG. 6 and FIG. 7, a planar part 112A1 is formed on the inner wall surface of the display casing 112 in the display area 112A toward the display screen 141 in the present application, the planar part 112A1 is arranged in an arch shape in the circumferential direction of the electric toothbrush 1, so that the inner surface of the display casing 112 in the display casing 112 corresponding to the light-transmitting area is configured to be recessed in a direction away from the accommodation cavity 111E. The inner wall surface of the display casing 112 in the display area 112A forms a planar part 112A1 that extends in the length direction of the electric toothbrush 1, the number of the planar parts 112A1 may be multiple, the multiple planar parts 112A1 are spliced in the circumferential direction of the electric toothbrush 1 to form an arch, so that the wall thickness of the display area 112A tends to decrease from the side to the middle on both the inner and outer wall surfaces, the structure molded by the display area 112A is closer to the structure of a concave lens, in this way, the changes of the structure of the outer wall surface of the display area 112A being recessed toward the middle part and the changes in the contents displayed on the screen observed by the user are relatively consistent, so that the display effects are further improved. Certainly, in other embodiments, the planar portion 112A1 can also be one piece as a whole.

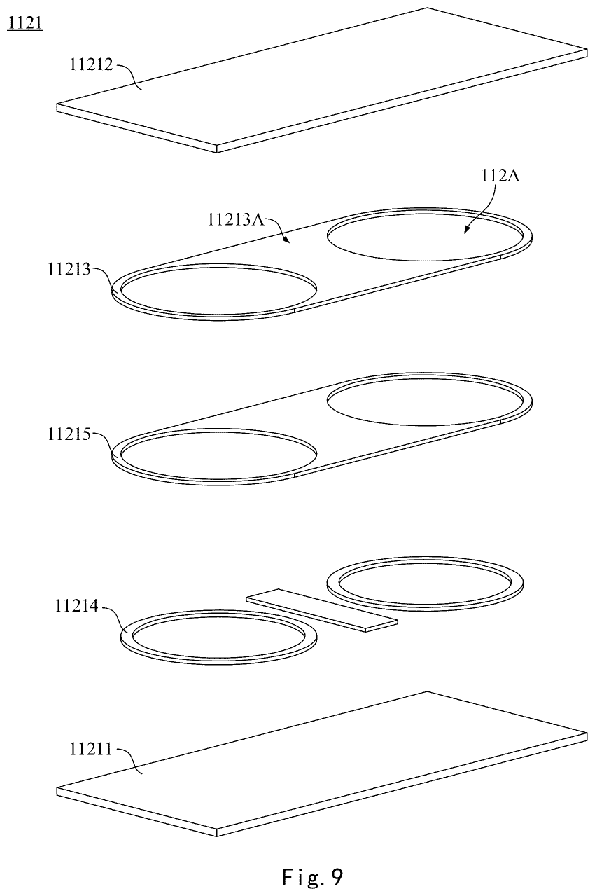

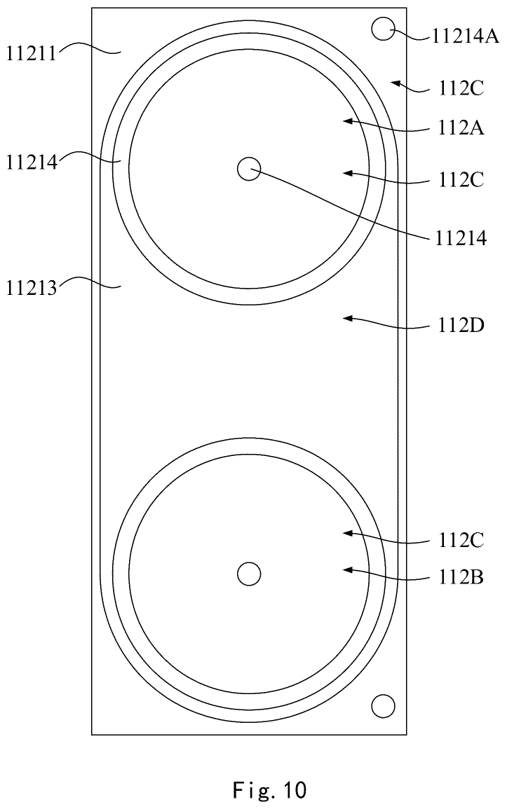

As illustrated in FIG. 1, FIG. 9, and FIG. 10, the present application also provides a display casing 112, the display casing 112 including a light-transmitting substrate 11211, a light-transmitting appearance layer 11212, a middle layer 11213 and a pattern layer 11214, the light-transmitting substrate 11211 has a light-transmitting property; the light-transmitting appearance layer 11212 has a light-transmitting property, the middle layer 11213 is arranged between the light-transmitting substrate and the light-transmitting appearance layer, the middle layer 11213 includes a Light-shielding part with non-light-transmitting and a light-transmitting part with light-transmitting, the Light-shielding part defines a Light-shielding 11213A, and the light-transmitting part defines a light-transmitting area. In some embodiments, an area printed with the non-light-transmitting coating in the middle layer forms a Light-shielding area 11213A, and an area which is not printed with the non-light-transmitting coating in the middle layer 11213 is formed a display area 112A, i.e., that is the light-transmitting area, a pattern layer 11214 is provided on the Light-shielding area 11213A and is located between the Light-shielding area 11213A and the light-transmitting substrate 11211, and formed with a preset pattern or preset text, when a user presses a button 113, a controller controls a corresponding light-emitting element 14 to emit light, a light emitted by the light-emitting element is emitted out of the electric toothbrush through the light-transmitting substrate 11211 and the light-transmitting appearance layer 11212 in sequence, and illuminates the pattern layer 11214, so that the preset pattern or preset text is highlighted, thereby facilitating the user to obtain the display contents of the electric toothbrush 1 by highlighting the preset pattern or preset text. For example, the preset pattern of the pattern layer 11214 includes annular shape patterns surrounding the display area 112A to increase the aesthetics of the electric toothbrush 1, and the preset texts includes product identification texts.

It may be understood that in another embodiments, the pattern layer 11214 may be disposed in an area corresponding to the display area 112A between the light-transmitting substrate 11211 and the light-transmitting appearance layer 11212, and formed with a preset pattern or preset text, similarly after the corresponding light-emitting member 14 is lit up, the preset pattern or preset text may be illuminated, so that the preset pattern or preset text is highlighted, thereby facilitating the user to obtain the displayed contents of electric toothbrush 1 through the highlighted preset pattern or preset text.

As illustrated in FIG. 1, FIG. 9, and FIG. 10, the display casing 112 further includes: an optical film layer 11215, the optical film layer 11215 is formed on the pattern layer 11214, and the light-transmitting appearance layer 11212, the optical film layer has a three-dimensional texture pattern, to make the pattern layer 11214 to be more stereoscopic, and improve the aesthetics of the electric toothbrush 1. It may be understood that in some embodiments, the optical film layer 11215 is formed on the pattern layer 11214, and the middle layer 11213. It may be understood that the optical film layer 11215 is formed on the pattern layer 11214, the light-transmitting appearance layer 11212 and the middle layer 11213, all of them can improve the aesthetics of the electric toothbrush 1.

The embodiments of the present disclosure provide a molding process of handle housing 11 of an electric toothbrush 1, which is suitable for manufacturing the handle housing 11, a manufacturing method of the handle housing includes: molding out the display casing 112 and the machine casing 111, the machine casing is connected to the display casing 112, and molding out the button 113 on the display casing 112, to integrally mold the button 113 and the display casing 112.

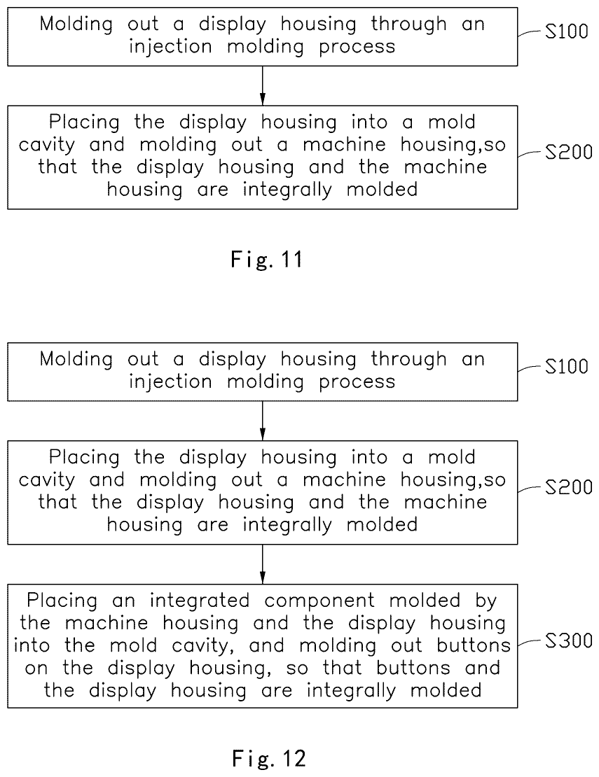

As illustrated in FIG. 1, and FIG. 11, the molding process of handle housing 11 includes the following steps: step 100, molding out a display casing 112 through an injection molding process.

In step 100, a raw material of the display casing 112 may be injected into a mold cavity, so that the raw material of the display casing 112 is filled into the mold cavity, and after waiting for the raw material to cool down, the display casing 112 is obtained through a demolding process.

In step S200, placing the display casing 112 into the mold cavity and molding out a machine casing 111, so that the display casing and the machine casing are integrally molded.

In step S200 placing the display casing 112 into the mold cavity, and injecting a raw material of the machine casing 112 into a mold cavity, so that the machine casing 111 is formed on the circumference side of the display casing 112, thereby making the machine casing 111 and the display casing 112 to be integrally molded, and eliminating the gap between the display casing 112 and the machine casing 111. Dirt or grime will not accumulate in the gap, thereby facilitating the user to clean the outer surface of the handle housing 11 to provide reliable protections for hygiene of users.

The display casing 112 may be injection molded using a display casing 112 mold, and then placing the display casing 112 into a machine casing 111 mold, and the machine casing 111 is integrally molded. For example, the display casing 112 and the machine casing 111 may share a set of molds and occupy different cavities in the mold respectively, thereby facilitating the display casing 112 and the machine casing 111 to be integrally molded through a double injection molding process. Moreover, since the display casing 112 and the machine casing 111 share a set of molds, compared to using two sets of molds to form the display casing 112 and the machine housing 111 respectively, the design and production cost of the mold may be reduced to reduce the research and development cost, and after molding out the display casing in the mold cavity of the display casing 112, there is no need to transfer the display casing 112, the machine casing 111 may be directly molded in the mold cavity of the machine casing 111 adjacent to the display casing 112 cavity, to reduce the transfer and secondary assembly of the display casing 112, thereby improving the molding efficiency of the handle housing 11.

As illustrated in FIG. 1, and FIG. 12, after step S200, the molding process of the handle housing 11 further includes: step S300, placing an integrated body molded by the machine casing 111 and the display casing 112 into the mold cavity, and molding out the button 113 on the display casing 112, so that the button 113 and the display casing 112 are integrally molded.

In step S300, placing an integrated body molded by the machine casing 111 and the display casing 112 into the mold cavity, for molding out the soft rubber part 1131 in the button holes 112B of the display casing 112, and molding out an inner extension part 1132 at one end of the soft rubber part 1131 that penetrates into the interior of the display casing 112, so that the inner extension part 1132 is extended along an inner wall of the display casing 112, and the inner extension part 1132 is integrally molded with the inner wall of the display casing 112, thereby increasing the contact area between the button 113 and the display casing 112, and increasing the connection stability between the display casing 112 and the machine casing 111. For example, the mold cavity of the button 113, the mold cavity of the display casing, and the mold cavity of the machine casing 111 are a part of the same mold, so the button 113, the display casing 112, and the machine casing 111 may be molded out in different cavities in one mold, so that the button 113, the display casing 112 and the machine casing 111 are integrally molded, for simplifying the process steps and improving the molding efficiency.

In some embodiments, the inner extension part 1132 may also be extended from the soft rubber part 1131 through the inner wall of the display casing 112 to the inner wall of the machine casing 112, so that the inner extension part 1132 is also integrally molded with the inner wall of the machine casing 111.

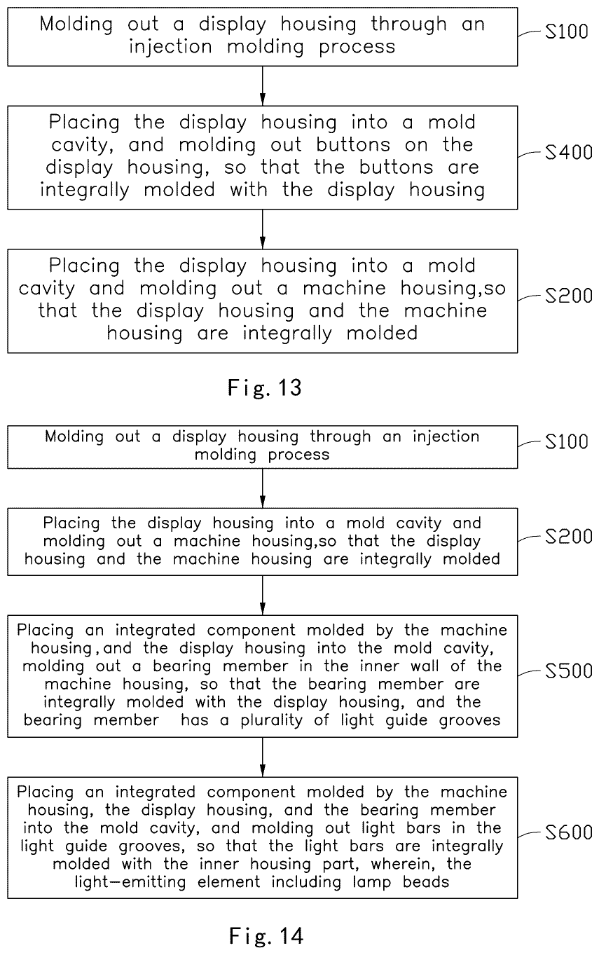

As illustrated in FIG. 1, and FIG. 13, before step S200, the molding process of the handle housing 11 further includes: step S400, placing the display casing 112 into the mold cavity, and molding out the button 113 on the display casing 112, so that the button 113 are integrally molded with the display casing 112.

In step S400, placing the display casing 112 into the mold cavity, the soft rubber part 1131 is molded out in the button holes 112B of the display casing 112, and molding out an inner extension part 1132 at one end of the soft rubber part 1131 that penetrates into the interior of the display casing 112, thereby increasing the contact area between the button 113 and the display casing 112, and the connection stability between the display casing 112 and the machine casing 111.

As illustrated in FIG. 1, FIG. 2, FIG. 3, and FIG. 14, after step S200, the molding process of the handle housing 11 further includes: step S500, placing an integrated body molded by the machine casing 111, and the display casing112 into the mold cavity, molding out a bearing member 15 in the inner wall of the machine casing 111, so that the bearing member 15 are integrally molded with the display casing 112, and the bearing member 15 has a plurality of light guide grooves 15A.

In step S500, placing an integrated body molded by the machine casing 111, and the display casing 112 into the mold cavity, so that the bearing member 15 is molded out on the inner wall of the machine casing 111 through a double injection molding process, and the bearing member 15 is integrally molded with the display casing 112, and the bearing member 15 has a plurality of light guide grooves 15A.

In step S600, placing an integrated body molded by the machine casing 111, the display casing112, and the bearing member 15 into the mold cavity, and molding out light bars 16 in the light guide grooves 15A, so that the light bars 16 are integrally molded with the inner casing part 1122, and the light-emitting element 14 including lamp beads 142.

In step S600, an integrated body molded by the machine casing 111, the display casing 112, and the bearing member 15 further is placed into the mold cavity, to mold out the light bars 16 in the light guide grooves 15A, so that the light bars 16 are integrally molded with the machine casing 111. It may be understood that the light bars 16 are integrally molded with the display casing 112, the light bars 16 further may be integrally molded with the machine casing 111 and the display casing 112, and all of them may make the lights emitted by the lamp beads to enter the light bars 16, and the lights are reflected and refracted in the light bars 16, for lighting up the light bars 16. the lights of the light bars 16 are emitted to the outside of the machine casing 111 through the display area 112A, so that the display area 112A is lit up, thereby facilitating that the users obtain the display contents of the electric toothbrush 1 through the lit display area 112A.

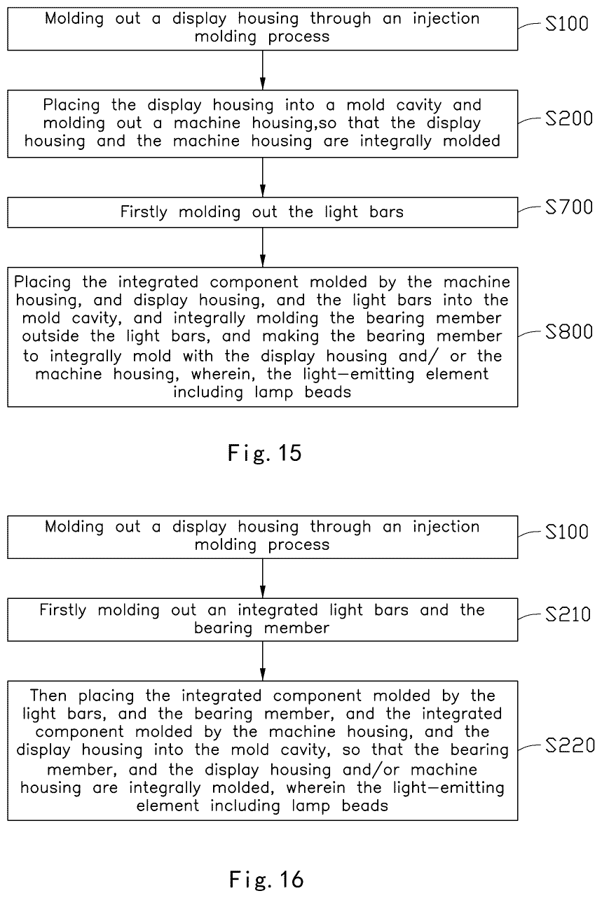

As illustrated in FIG. 1, FIG. 2, FIG. 3, and FIG. 15, after step S200, the molding process of the handle housing 11 further includes: step S700, firstly molding out the light bars 16.

In step S700, the light bars 16 are molded out in the mold cavity firstly, to improve the molding quality of the light bars 16.

In step S800, placing the integrated body molded by the machine casing 111, and display casing 112, and the light bars 16 into the mold cavity, and integrally molding the bearing member 15 outside the light bars 16, and making the bearing member 15 to integrally mold with the display casing 112 and/or the machine casing 111, the light-emitting element 14 including lamp beads 142.

In step S800, placing the integrated body molded by the machine casing 111, and display casing 112, and the light bars 16 into the mold cavity, integrally molding the bearing member 15 outside the light bars 16, and making the bearing member 15 to integrally mold with the display casing 112, so that the light bars 16 and the display casing 112 are integrally molded. It may be understood that the bearing member 15 may also be integrally molded with the machine casing 111 and the display casing 112.

As illustrated in FIG. 1, FIG. 2, FIG. 3, and FIG. 16, step S200 including step S210, firstly molding out an integrated light bars 16 and the bearing member 15.

In step S200, integrally molding out the light bars 16 and the bearing member 15 through the double injection molding process in the mold cavity. It may be understood that the light bars 16 may be firstly molding out, and then the bearing member 15 is molded out at the circumference side of the light bars 16, so that the light bars 16 and the bearing member 15 are integrally molded. It may be understood that the bearing member 15 may be firstly molding out, to make the bearing member 15 has a plurality of light guide grooves 15A, and then the light bars 16 are molded out in the light guide grooves 15A, for integrally molding the light bars 16 and the bearing member 15.

In step S220, then placing the integrated body molded by the light bars 16, and the bearing member 15, and the integrated body molded by the machine casing 111, and the display casing 112 into the mold cavity, so that the bearing member 15, and the display casing 112 and/or machine casing 111 are integrally molded, the light-emitting element 14 including lamp beads 142.

In step S220, placing the integrated body molded by the light bars 16, and the bearing member 15, and the integrated body molded by the machine casing 111, and the display casing 112 into the mold cavity, so that the bearing member 15, and the display casing 112 and/or machine casing 111 are integrally molded. It may be understood that the bearing member 15 and the machine casing 111 may be integrally molded, the bearing member 15 and the display casing 112 may be integrally molded, and the bearing member 15, and the display casing 112 and machine casing 111 may be integrally molded.

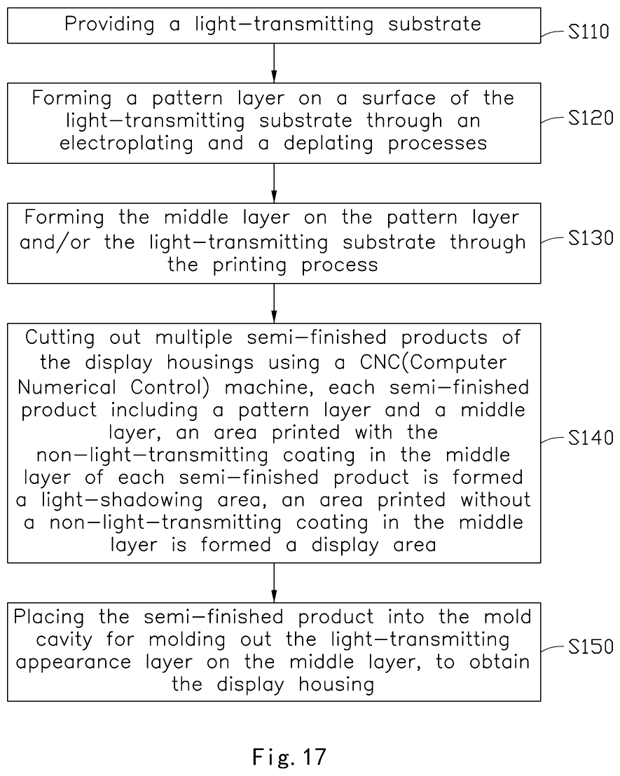

As illustrated in FIG. 1, FIG. 2, FIG. 3, and FIG. 17, the present disclosure provides a molding process of the display casing 112, the molding process of the display casing 112 includes: step S110, providing a light-transmitting substrate 11211.

In step S110, the light-transmitting substrate 11211 which has a light transmission property may be formed in the mold cavity through an injection molding process.

In step S120, forming a pattern layer 11214 on a surface of the light-transmitting substrate 11211 through an electroplating and a deplating processes.

In step S120, a preset color layer is covered on a surface of one side of the light-transmitting substrate 11211 through an electroplating process, and then the preset color layer is deplated to retain a part of the preset color layer on the surface of one side of the light-transmitting substrate 11211 for forming the pattern layer 11214. For example, the color of the preset color layer may be gold, blue, red, etc., in the embodiment of the present disclosure, the color of the preset color layer is not specifically limited. For example, the pattern layer 11214 may including patterns with a preset color and texts with a preset color. For example, the pattern layer 11214 may including annuluses with a preset color.

It may be understood that patterns with a preset color may be formed on the surface of the light-transmitting substrate 11211 through electroplating and deplating processes, and then preset texts may be formed on the surface through a printing process.

In step S130, forming the middle layer 11213 on the pattern layer 11214 and/or the light-transmitting substrate 11211 through the printing process.

In step S130, performing an optical coating on the pattern layer 11214 to obtain an optical film layer 11215, and press out a 3D texture pattern on the surface of the optical film layer 11215, so that the pattern layer 11214 has a 3D texture pattern, and the pattern layer 11214 may be made more bulging to improve the identification of the electric toothbrush 1, and a non-light-transmitting coating may be printed on a local area of the optical film layer 11215 to form a Light-shielding area 11213A, and an area without printing a non-light-transmitting coating is formed a display area 112A to form the middle layer 11213, thereby facilitating a light emitted by the light-emitting element 14 to be emitted out of the handle housing 11 through the display area 112A, and facilitating the users to obtain a current operating mode of the electric toothbrush 1 through the display area 112A. For example, the non-light-transmitting coating may be formed on the local area of the optical film layer 11215 through the ink printing or roll-stamping process.

It may be understood that the optical coating may be performed on the light-transmitting substrate 11211 to obtain the optical film layer 11215, and press out a 3D texture pattern on the surface of the optical film layer 11215, so that the non-pattern layer 11214 of the light-transmitting substrate 11211 has a 3D texture pattern, to make the display casing 112 to have a 3D texture pattern with a larger area for improving the aesthetics of the electric toothbrush 1, a non-light-transmitting coating may be printed on a local area of the optical film layer 11215 to form a Light-shielding area 11213A, and an area without printing a non-light-transmitting coating is formed a display area 112A to form the middle layer 11213.

It may be understood that the optical coating may be performed on the pattern layer 11214 and the light-transmitting substrate 11211 to obtain the optical film layer 11215, and press out a 3D texture pattern on the surface of the optical film layer 11215, to make the display casing 112 to have a 3D texture pattern with a larger area for improving the aesthetics of the electric toothbrush 1, a non-light-transmitting coating may be printed on a local area of the optical film layer 11215 to form a Light-shielding area 11213A, and an area without printing a non-light-transmitting coating is formed a display area 112A to form the middle layer 11213.

In step S140, cutting out multiple semi-finished products of the display casings 112 using a CNC (Computer Numerical Control) machine, each semi-finished product including a pattern layer 11214 and a middle layer 11213, an area printed with the non-light-transmitting coating in the middle layer 11213 of each semi-finished product is formed a Light-shielding area 11213A, an area printed without a non-light-transmitting coating in the middle layer 11213 is formed a display area 112A.

In step S140, after forming the middle layer 11213 on the pattern layer 11214 and/or the light-transmitting substrate 11211 through the printing process, the semi-finished display casing 112 has a clipping area 112C and a reserved area 112D, the CNC machine cutting the clipping area 112C according to a preset trajectory to form a semi-finished product of the display casing 112. It may be understood that for facilitating the reference positioning of the CNC machine, when the pattern layer 11214 may be formed on the surface of the light-transmitting substrate 11211 through an electroplating and a deplating processes, alignment patterns 11214A are formed in the clipping area 112C. It may be understood that it may be also forming the alignment patterns 11214A in the clipping area 112C through the printing process. For example, the alignment patterns 11214A may be positioning points.

In some embodiments, after cutting the semi-finished display casing 112, the semi-finished display casing 112 may have a clipped button hole 112B, and an un-clipped and light-transmitting display area 112A. In another embodiments, after cutting the semi-finished display casing 112, the semi-finished display casing 112 may have a clipped button hole 112B, and a clipped display area 112A.

In step S150, placing the semi-finished product into the mold cavity for molding out the light-transmitting appearance layer 11212 on the middle layer 11213, to obtain the display casing 112.

In step S150, after placing the semi-finished product into the mold cavity, the light-transmitting appearance layer 11212 may be molded out on the middle layer 11213, the light-transmitting substrate 11211 may be the inner casing part 1122 of the display casing 112, so that the display casing 112 may be obtained.

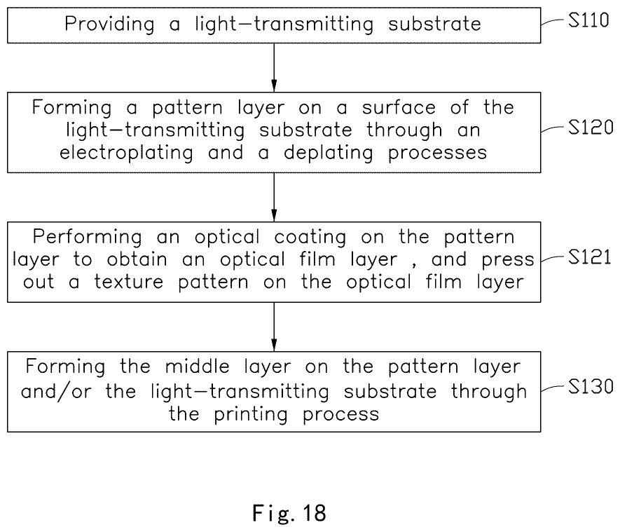

As illustrated in FIG. 1, FIG. 9, FIG. 10, and FIG. 18, before step S130, the molding process of the handle housing 11 further includes: step S121, performing an optical coating on the pattern layer 11214 to obtain an optical film layer 11215, and press out a texture pattern on the optical film layer 11215.

In step S130, performing an optical coating on the pattern layer 11214 to obtain an optical film layer 11215, and press out a texture pattern on the surface of the optical film layer 11215 to make the pattern layer 11214 to have a 3D texture pattern, so that the pattern layer 11214 may be made more bulging to improve the identification of the electric toothbrush 1.

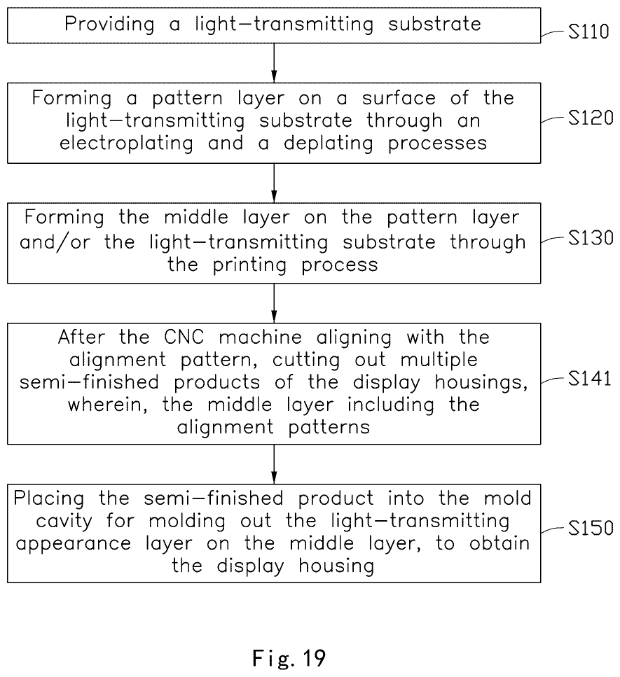

As illustrated in FIG. 1, FIG. 9, FIG. 10, and FIG. 19, step S140 includes step S141, after the CNC machine aligning with the alignment pattern 11214A, cutting out multiple semi-finished products of the display casings 112, wherein, the middle layer 11213 including the alignment patterns 11214A.

In step S141, for facilitating the reference positioning of the CNC machine, when the pattern layer 11214 may be formed on the surface of the light-transmitting substrate 11211 through an electroplating and a deplating processes, the alignment patterns 11214A may be formed in the clipping area 112C. It may be understood that it is also forming the alignment patterns 11214A in the clipping area 112C through the printing process. For example, the positioning patterns may be positioning points. After the CNC machine is aligned through the alignment pattern 11214A, and the CNC machine is moved along a preset trajectory, to cut out multiple semi-finished products of display casings 112. For example, after cutting the semi-finished display casings 112, the semi-finished display casing 112 may have a clipped button hole 112B, and a un-clipped and light-transmitting display area 112A. in another embodiments, after cutting the semi-finished display casings 112, the semi-finished display casing 112 may have a clipped button hole 112B, and a clipped display area 112A.

The same or similar reference numerals in the drawings of the present embodiments correspond to the same or similar components. In the description of the present application, it should be understood that the orientation or position relationship indicated by the term such as “upper”, “lower”, “left”, “right” or the like is based on the orientation or position relationship as shown in the drawings, which is merely to facilitate the description of the present application and simplification of the description, rather to indicate or imply that an indicated device or element have to be provided with a specific orientation or be constructed or operated at a specific orientation. Therefore, the terms describing position relationships in the drawings are only used for exemplary illustration, and are not to be construed as limitation to the present application. For those of ordinary skill in the art, the specific meaning of the above terms may be understood on a case-by-case basis.

The above description only describes preferred embodiments of the present application, and is not intended to limit the present application, and any modifications, equivalent substitutions and improvements made within the spirit and principles of the present application should be included in the protection scope of the present application.

What is claimed is:

1. An electric toothbrush comprising:
a handle housing including:
a machine casing comprising an accommodating cavity,
a display casing connected to the machine casing, the display casing comprising a light-transmitting area and at least one button hole penetrating into the display casing;
at least one button correspondingly accommodated into the at least one button hole; and
a movement component and a light-emitting element, each accommodated in the accommodating cavity,
wherein the light-emitting element is disposed corresponding to the light-transmitting area, such that light emitted by the light-emitting element are emitted from the light-transmitting area, and
at least a part of the at least one button is molded integrally as an integral part, with a hole wall of the corresponding button hole.

2. The electric toothbrush according to claim 1, wherein the each of at least one button comprises an edge part that matches a shape of the hole wall of the corresponding button hole, the at least one button is integrally molded with the hole wall of the corresponding button hole through the edge part, such that each of the at least one button and the hole wall of the corresponding button hole are integrally molded as an integral part.

3. The electric toothbrush according to claim 2, wherein the at least one button further comprises at least one inner extension part connected to the edge part, the inner extension part is extended along a direction away from the at least one button hole to an inner wall of the display casing, and the inner extension part and the inner wall of the display casing are integrally molded as an integral part.

4. The electric toothbrush according to claim 3, wherein the at least one inner extension part is extended through the inner wall of the display casing to the inner wall of the machine casing, and the at least one inner extension part and the inner wall of the machine casing are integrally molded as an integral part.

5. The electric toothbrush according to claim 1, wherein the at least one button comprises:
a pressing part accommodated in the at least one button hole, and
at least one inner extension part connected to the pressing part, the at least one inner extension part is extended from the pressing part through an inner wall of the display casing to the inner wall of the machine casing, and
the at least one inner extension part, the inner wall of the display casing, and the inner wall of the machine casing are integrally molded as an integral part.

6. The electric toothbrush according to claim 1, wherein the at least one button includes: a soft rubber part accommodated in the at least one button hole, and a circumference edge of the soft rubber part is integrally molded with the hole wall of the at least one button hole, so that the at least one button and the display casing are integrally molded as an integral part, and
at least one part of the soft rubber part is exposed on the display casing for being pressed.

7. The electric toothbrush according to claim 1, wherein the display casing and the machine casing are integrally molded as an integral part.

8. The electric toothbrush according to claim 1, wherein the machine casing comprises an installation groove connected to the accommodating cavity,
the display casing comprises:
an outer casing part installed in the installation groove, and
an inner casing part disposed on the side of the outer casing part adjacent to the movement component,
wherein the machine casing and the display casing are connected by
the outer casing part and the groove wall of the installation groove are integrally molded as a whole; or
the inner casing part and the inner wall of the machine casing are integrally molded as a whole; or
the outer casing part and the groove wall of the installation groove are integrally molded as a whole, and the inner casing part and the inner wall of the machine casing are integrally molded as an integral part.

9. The electric toothbrush according to claim 1, wherein,
the display casing comprises:
a light-transmitting substrate,
a light-transmitting appearance, and
a patterned middle layer provided between the light-transmitting substrate and the light-transmitting appearance layer, and
the patterned middle layer includes a Light-shielding part and a light-transmitting part defining a light-transmitting area.

10. The electric toothbrush according to claim 9, wherein
the display casing further comprises:
a pattern layer selectively disposed on one of a first position or a second position, the first position disposed between the Light-shielding part and the light-transmitting substrate corresponding to the Light-shielding part, and the second position disposed between the light-transmitting substrate and the light-transmitting appearance layer corresponding to the light-transmitting part and formed with a preset pattern.

11. The electric toothbrush according to claim 10, wherein
the display casing further comprises an optical film layer disposed between the light-transmitting substrate and the light-transmitting appearance layer, the optical film layer has a three Dimensions (3D) texture pattern for making the pattern layer to be more stereoscopic.

12. The electric toothbrush according to claim 1, wherein the light-emitting element comprises a display screen with a light-emitting area,
the machine casing comprises at least one light-transmitting hole, and the at least one light-transmitting hole is at least one through-hole opened at the bottom of an installation groove,
the number of light-transmitting holes is multiple, the plurality of light-transmitting holes are arranged at intervals along the length direction of the handle housing in sequence, the display screen comprises a plurality of light-emitting areas, and corresponds to the light-transmitting holes in position by one-to-one correspondence.

13. The electric toothbrush according to claim 1, wherein
an outer wall surface of the display casing corresponding to the light-transmitting area is concaved toward the direction of the accommodating cavity.

14. The electric toothbrush according to claim 13, wherein
the light-emitting element includes a display screen,
a distance between the outer wall surface of the display casing corresponding to the light-transmitting area, and the display screen is gradually decreased from the opposite both sides of the light-transmitting area in the length direction of the machine casing to the middle part, or decreased and then remained unchanged.

15. The electric toothbrush according to claim 14, wherein
a direction perpendicular to the length direction of the machine casing and parallel to a substrate surface of the display screen is defined as a left-right direction, the distance between the outer wall surface of the display casing corresponding to the light-transmitting area, and the display screen is gradually decreased from the opposite both sides of the light-transmitting area in the left-right direction to the middle part.

16. The electric toothbrush according to claim 13, wherein
an area enclosed by the outer contour of the display area is less than six (6) square centimeters.

17. The electric toothbrush according to claim 13, wherein
a planar part is disposed on an inner wall surface of the display casing corresponding to the light-transmitting area,
the planar part is arranged in an arch shape in the circumferential direction of the electric toothbrush, so that the inner surface of the display casing corresponding to the light-transmitting area recesses in a direction away from the accommodation cavity.

18. A manufacturing method of a handle housing, comprises:
a machine casing accommodated a movement component of the electric toothbrush,
a display casing having a light-transmitting function, and
at least one button controlling the electric toothbrush, the manufacturing method comprising:
molding out the display casing,
molding out the machine casing, wherein the machine casing is connected to the display casing, and
molding out the at least one button on the display casing, such that the at least one button and the display casing are an integral part.

19. The manufacturing method according to claim 18, wherein molding out the display casing and the machine casing comprises:
molding out the display casing by an injection molding process,
molding out the machine casing on the display casing by double injection, such that the display casing and the machine casing are an integral part.

20. The manufacturing method according to claim 18, wherein molding out the display casing and the machine casing, and molding out the at least one button on the display casing comprises:
molding out the display casing by injection molding,
molding out the at least one button on the display casing by double injection, such that the at least one button and the display casing form a first integrated body, and
molding out the machine casing on the first integrated body molded by injection molding, such that the display casing and the machine casing are an integral part.
